(19) United States
(12) Patent Application Publication
(10) Pub. No.: US 2026/0087707 A1
(43) Pub. Date: Mar. 26, 2026

(54) METHODS, SYSTEMS AND COMPUTER PROGRAM PRODUCTS FOR AN AVATAR CREATION AND EDITING SYSTEM

(71) Applicant: Meta Platforms, Inc., Menlo Park, CA (US)

(72) Inventors: David Abraham Harris, Redwood City, CA (US); Leon Zhan, Vienna, VA (US); Anton Pidkuiko, London (GB); Ya Wang, Foster City, CA (US); Rahul Kumar, London (GB); Igor Lifar, San Francisco, CA (US)

(21) Appl. No.: 19/337,143

(22) Filed: Sep. 23, 2025

Related U.S. Application Data
(60) Provisional application No. 63/698,204, filed on Sep. 24, 2024.

(51) Int. Cl. G06T 11/60; G06F 40/40

(52) U.S. Cl. CPC G06T 11/60; G06F 40/40; G06T 2200/24

(57) ABSTRACT

An artificial intelligence-based avatar creation and editing system and method are disclosed. The system may receive user input associated with a set of avatar modifications. The system may further process the input, by a large language model fine-tuned, to facilitate avatar editing. The system may further generate, based on the processed user input, the set of avatar modifications within constraints of an available asset catalog. The system may further apply the generated set of avatar modifications to update a target avatar. The system may further output the updated target avatar to a display.

### CROSS-REFERENCE TO RELATED APPLICATIONS

This application claims the benefit of U.S. Provisional Application No. 63/698,204, filed Sep. 24, 2024, and titled “ARTIFICIAL INTELLIGENCE AVATAR CREATION AND EDITING SYSTEM,” the entire content of which is incorporated herein by reference.

### TECHNOLOGICAL FIELD

The present disclosure relates generally to avatar creation and customization in virtual environments, and more specifically to an artificial intelligence-based system for creating and editing avatars using natural language processing and generative artificial intelligence techniques.

### BACKGROUND

In virtual environments, users often represent themselves through digital avatars. Conventionally, avatar creation and customization have been manual processes, requiring users to navigate complex menus and adjust numerous parameters. This process can be time-consuming and often limits users'ability to create avatars that truly represent them. Additionally, traditional avatar editors are typically constrained by pre-defined assets, limiting the range of customization options available to users.

### BRIEF SUMMARY

Some examples of the present disclosure may be directed to natural language processing for avatar customization utilizing large language models (LLMs). In some examples, an avatar editing system may be configured to implement the aforementioned natural language processing to allows users to apply edits to avatars in a matter of seconds from simple text/voice commands, thereby allowing for a faster avatar creation and editing experience as compared to previous time-intensive approaches often requiring users to manually review potentially hundreds to thousands of options for making simple edits to avatars. In this regard, the avatar editing system configured to implement the natural language processing features of the exemplary aspects of the present disclosure may conserve (e.g., reduce/save) processing capacity resources of a communication device(s) in relation to conventional approaches that manually review potentially hundreds to thousands of options for making edits to avatars, which may inordinately constrain processing resources of a communication device(s).

The system of the exemplary aspects of the current disclosure may receive user input in the form of natural language text or voice commands, and may process the user input using a large language model fine-tuned for avatar editing. The system may also generate modifications to an avatar based on the processed input. The system may utilize existing assets from an asset catalog and/or create custom elements using generative AI techniques. The system may also integrate social media trend analysis to provide users with inspiration for avatar modifications.

In one example of the present disclosure, a method is provided. The method may include receiving a user input associated with a set of avatar modifications. The method may further include processing the user input, by a large language model fine-tuned, to facilitate avatar editing. The method may further include generating, based on the processed user input, the set of avatar modifications within constraints of an available asset catalog. The method may further include applying the generated set of avatar modifications to update a target avatar. The method may further include outputting the updated avatar to a display. In some examples, the display may be, or may include, a user interface to facilitate user interaction with the updated avatar via the user interface.

In another example of the present disclosure, an apparatus is provided. The system may include one or more processors and a memory including computer program code instructions. The memory and computer program code instructions are configured to, with at least one of the processors, cause the apparatus to at least perform operations including receiving a user input associated with a set of avatar modifications. The memory and computer program code are also configured to, with the processor(s), cause the apparatus to process the user input, by a large language model fine-tuned, to facilitate avatar editing. The memory and computer program code are also configured to, with the processor(s), cause the apparatus to generate, based on the processed user input, the set of avatar modifications within constraints of an available asset catalog. The memory and computer program code are also configured to, with the processor(s), cause the apparatus to apply the generated set of avatar modifications to update a target avatar. The memory and computer program code are also configured to, with the processor(s), cause the apparatus to output the updated avatar to a display. In some examples, the display may be, or may include, a user interface to facilitate user interaction with the updated avatar via the user interface.

In yet another example of the present disclosure, a computer program product is provided. The computer program product may include at least one non-transitory computer-readable medium including computer-executable program code instructions stored therein. The computer-executable program code instructions may include program code instructions configured to receive a user input associated with a set of avatar modifications. The computer program product may further include program code instructions configured to process the user input, by a large language model fine-tuned, to facilitate avatar editing. The computer program product may further include program code instructions configured to generate, based on the processed user input, the set of avatar modifications within constraints of an available asset catalog. The computer program product may further include program code instructions configured to apply the generated set of avatar modifications to update a target avatar. The computer program product may further include program code instructions configured to output the updated avatar to a display. In some examples, the display may be, or may include, a user interface to facilitate user interaction with the updated avatar via the user interface.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 illustrates an example block diagram illustrating the components of an avatar creation and editing system, in accordance with an example of the present disclosure.

FIG. 2 illustrates an example flowchart illustrating receiving user inputs and generating avatar modifications, in accordance with an example of the present disclosure.

FIGS. 3A, 3B, 3C, 3D and 3E illustrate example avatar modifications based on received user inputs, in accordance with example aspects of the present disclosure.

FIG. 4 illustrates a machine learning and training model framework, in accordance with example aspects of the present disclosure.

FIG. 5 illustrates an example computing system, in accordance with an example of the present disclosure.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the present disclosure will now be described more fully hereinafter with reference to the accompanying drawings, in which some, but not all examples of the present disclosure are shown. Various examples of the present disclosure may be embodied in many different forms and should not be construed as limited to the examples set forth herein. Like reference numerals refer to like elements throughout.

As used herein, the terms “data,” “content,” “information,” and similar terms may be used interchangeably to refer to data capable of being transmitted, received and/or stored in accordance with examples of the disclosure. Moreover, the term “exemplary,” as used herein, is not provided to convey any qualitative assessment, but instead merely to convey an illustration of an example. Thus, use of any such terms should not be taken to limit the spirit and scope of examples of the disclosure.

As defined herein, a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

As referred to herein, a resource(s), or an external resource(s) may refer to any entity or source that may be accessed by a program or system that may be running, executed or implemented on a communication device and/or a network. Some examples of resources may include, but are not limited to, HyperText Markup Language (HTML) pages, web pages, images, videos, scripts, stylesheets, other types of files (e.g., multimedia files) that may be accessible via a network (e.g., the Internet) as well as other files that may be locally stored and/or accessed by communication devices.

It is to be understood that the methods and systems described herein are not limited to specific methods, specific components, or to particular implementations. It is also to be understood that the terminology used herein is for the purpose of describing particular examples only and is not intended to be limiting.

It is to be understood that the methods and systems described herein are not limited to specific methods, specific components, or to particular implementations. It is also to be understood that the terminology used herein is for the purpose of describing particular examples only and is not intended to be limiting.

### Exemplary System Architecture

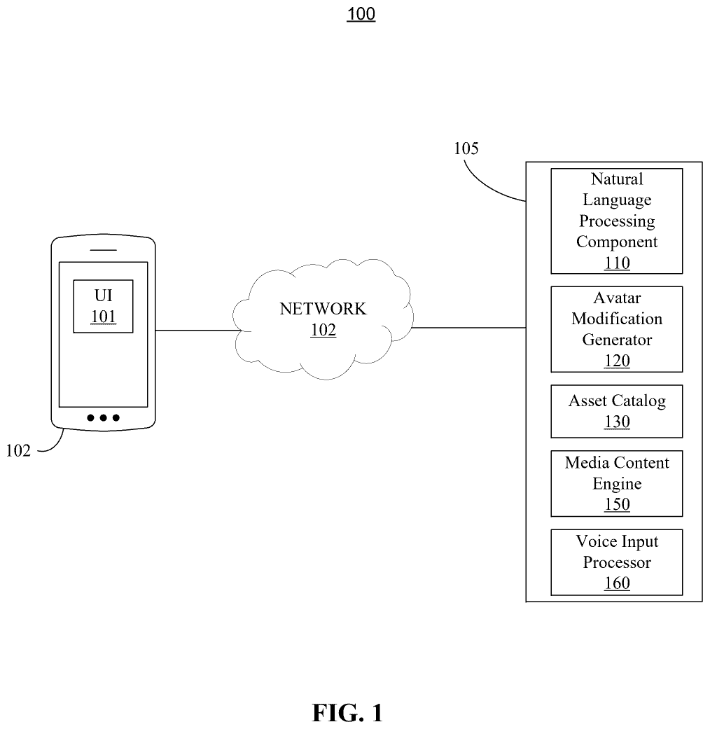

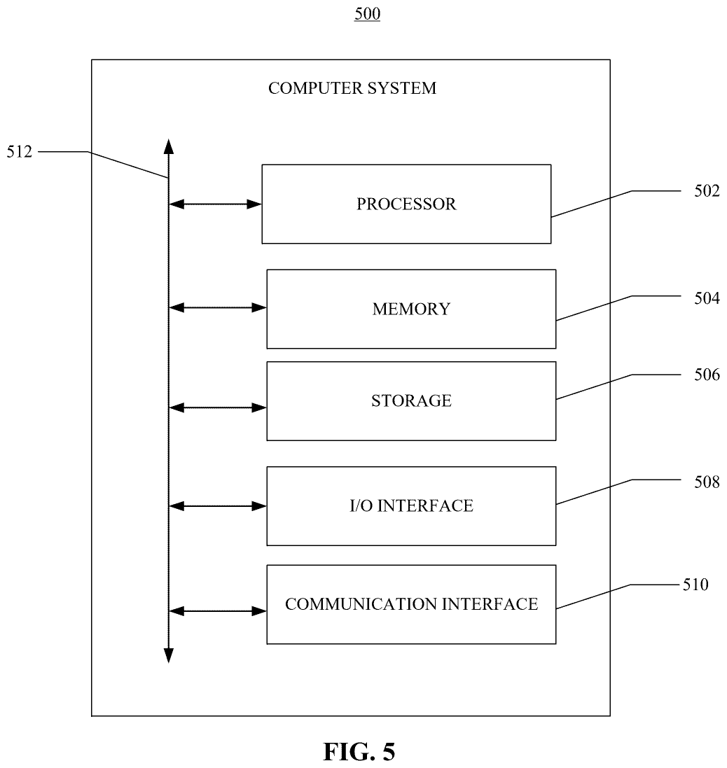

Reference is now made to FIG. 1, which is a block diagram illustrating the components of an avatar creation and editing system in a system 100. The system 100 may include a user device 102 and a network device 105. In some example aspects of the present disclosure, the user device 102 and the network device 105 may comprise the computer system 500 of FIG. 5. User interface (UI) 101 of the user device 102 may serve as the point of interaction for users, allowing them to input their avatar modification requests and view the results. Natural language processing component 110 may be responsible for interpreting user inputs and converting them into actionable instructions for avatar modification. Avatar modification generator 120 may take these instructions and creates a set of modifications to be applied to the avatar.

Asset catalog 130 may include a repository of pre-existing avatar elements that can be used in the modification process. The system 100 may represent avatars using a comprehensive set of key-value parameters, which may be thought of as the avatar's “DNA.” Each attribute of the avatar, from eye color to hip width, may be in access catalog defined by a specific key-value pair. Attributes may be predefined or subsequently generated and stored. For continuous attributes, values may range from 0 to 1, allowing for precise control over the avatar's appearance. This parametric representation enables efficient and flexible customization. The system 100 may utilize a representation of avatars that combines catalog-based assets with parameterized attributes. This hybrid approach may allow for both discrete selections and continuous adjustments, providing a rich and flexible customization framework. The avatar configuration may include specific assets drawn from a predefined catalog, such as particular t-shirt designs or preset face shapes. These assets may then be further customizable through associated value parameters. For instance, a selected shirt asset might have a color parameter that can be set to red, green, or any other available option. Moreover, many attributes of the avatar are represented by continuous parametric values that can be finely tuned. This includes physiological features like jaw size, nose width, shoulder breadth, and musculature, as well as style elements such as makeup intensity or clothing fit. The large language model (LLM) has the capability to manipulate these aspects. It can select new assets from the catalog, adjust the values associated with those assets (like colors), or modify the continuous parametric attributes (like facial feature dimensions). This comprehensive control extends across the avatar, encompassing both its physical characteristics (nose, lips, face shape, etc.) or its style elements (clothing, makeup, accessories, etc.). This multi-faceted approach enables the system 100 to interpret complex natural language requests and translate them into precise and nuanced avatar modifications.

Media content engine 150 provides inspiration for avatar modifications based on current popular styles and trends. Voice input processor 160 may allow for hands-free interaction by converting voice commands into text that may be processed. In some examples, the media content engine 150 may incorporate a social media trend analyzer that may be utilized to monitor trending content on social media platforms and analyze popular fashion trends, hairstyles, or accessories, among other things. The information gathered by the media content engine 150 may be utilized to suggest avatar modifications or styles to the user, helping them create avatars that reflect current trends, if desired. The components of the system 100 may be communicatively connected and may be functional or physical components on one device (e.g., network device 105) or distributed over multiple devices.

The system 100 may operate through a series of interconnected steps. The user may provide input through the UI 101. This input can be in the form of text or voice commands. If voice input is received, the voice input processor 160 converts it to text. The natural language processing component 110 then processes this input using a language model that has been fine-tuned specifically for avatar editing use cases. This fine-tuning allows the system 100 to accurately interpret user intentions even when they are expressed in colloquial or ambiguous language.

Once the user input has been processed, the avatar modification generator 120 creates a set of modifications to be applied to the avatar. This process may involve mapping the user's intentions to available assets in asset catalog 130. The asset catalog 130 may include a wide range of pre-existing avatar elements, including clothing items, hairstyles, facial features, and accessories. These elements may be tagged with metadata that allows the system 100 to match them with user requests effectively.

In addition, in cases where the user's request cannot be fulfilled using existing assets, the system 100 may leverage the avatar modification generator 120 to create custom elements. This module may use generative AI techniques, such as stable diffusion or variational autoencoders (VAEs), to produce unique assets based on the user's description. For example, if a user requests a specific style of clothing that does not exist in the asset catalog 130, the avatar modification generator 120 may create a new clothing item that matches the description.

To keep avatars current with popular styles and provide users with inspiration, the system 100 may utilize the media content engine 150. As discussed above, the media content engine 150 may incorporate a social media trend analyzer that may be utilized to monitor trending content on social media platforms and analyze popular fashion trends, hairstyles, or accessories, among other things. The information gathered by this analyzer may be used to suggest avatar modifications or styles to the user, helping them create avatars that reflect current trends, if desired. As one non-limiting example, the media content engine 150 may be configured to analyze social media trends describing cultural and fashion trends so that relevant suggestions/modifications may be presented to users with avatars.

Once the modifications are generated, they may be applied to the avatar, and the updated avatar is displayed to the user through the UI 101. The user may then provide feedback or make further modification requests, initiating another cycle of the process. In some examples, the system 100, described above, allows for an increase in the efficiency of avatar creation and modification by enabling users to apply edits to their avatars in a matter of seconds from simple text/voice commands, thereby reducing the time spent from users having to peruse among hundreds or thousands of options in a manual avatar editor utilized for making simple edits. As a result, the system 100 may facilitate minimizing network traffic the user device 102 and the network device 105, thereby conserving network bandwidth.

### Exemplary System Operation

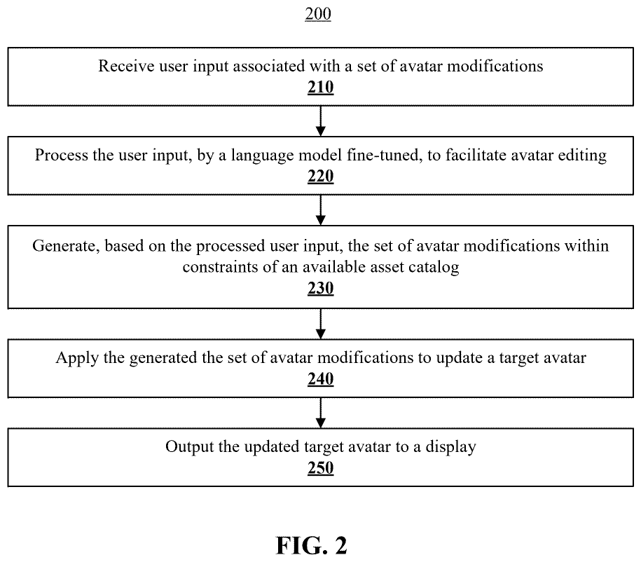

FIG. 2 illustrates an example flowchart depicting the process of receiving user input and generating avatar modifications. The process 200 begins when the system receives user input associated with a set of avatar modifications (e.g., operation/step 210). This input is then processed by a fine-tuned language model (e.g., an LLM) to facilitate avatar editing (e.g., operation/step 220), which interprets the user's intentions and converts them into specific modification instructions. Based on these instructions (e.g., the processed user input), the system 100 generates a set of avatar modifications within constraints of an available catalog (e.g., operation/step 230). In some examples, the set of avatar modifications may be generated utilizing the avatar modification generator 120 which may either select appropriate elements from the asset catalog 130 and/or create custom elements (e.g., by utilizing generative AI techniques). These modifications are then applied to create and/or update a target avatar (e.g., operation/step 240). Finally, the updated target avatar is output to a display (e.g., user interface 101, I/O interface 508) to facilitate display to the user (e.g., operation/step 250). In some examples, the display (e.g., user interface 101, I/O interface 508) may facilitate user interaction, by the user, with the updated target avatar via the display.

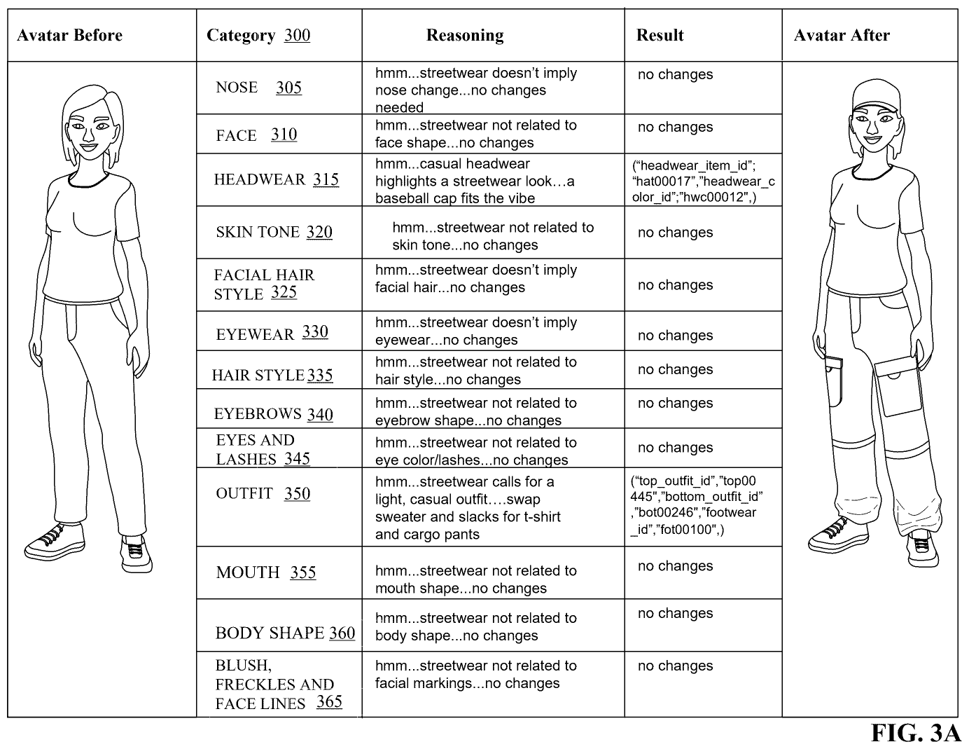

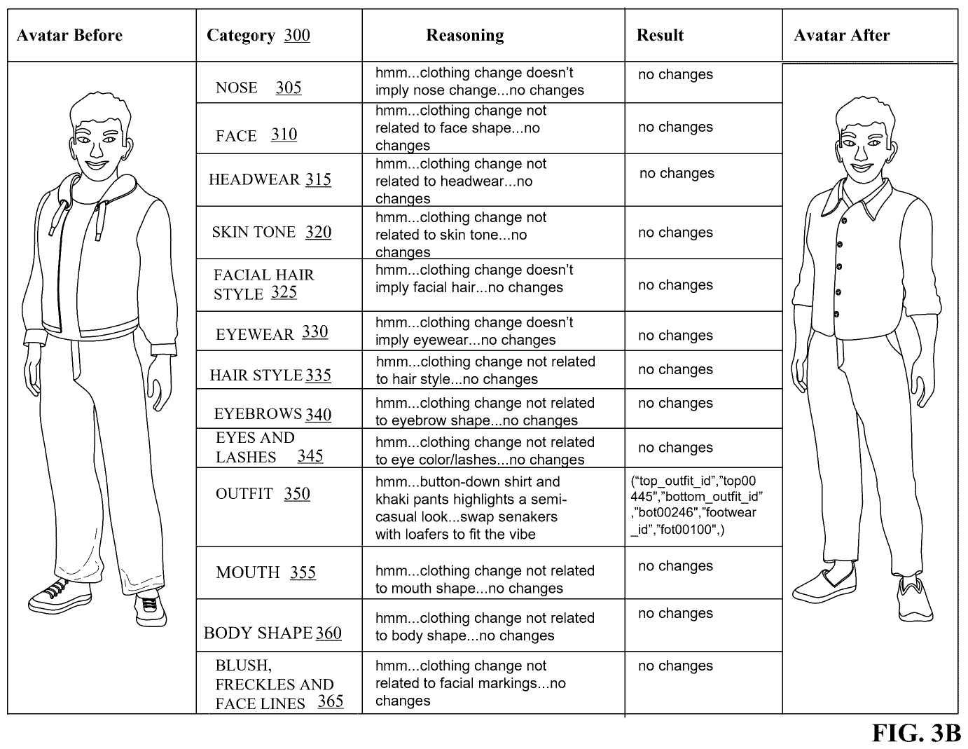

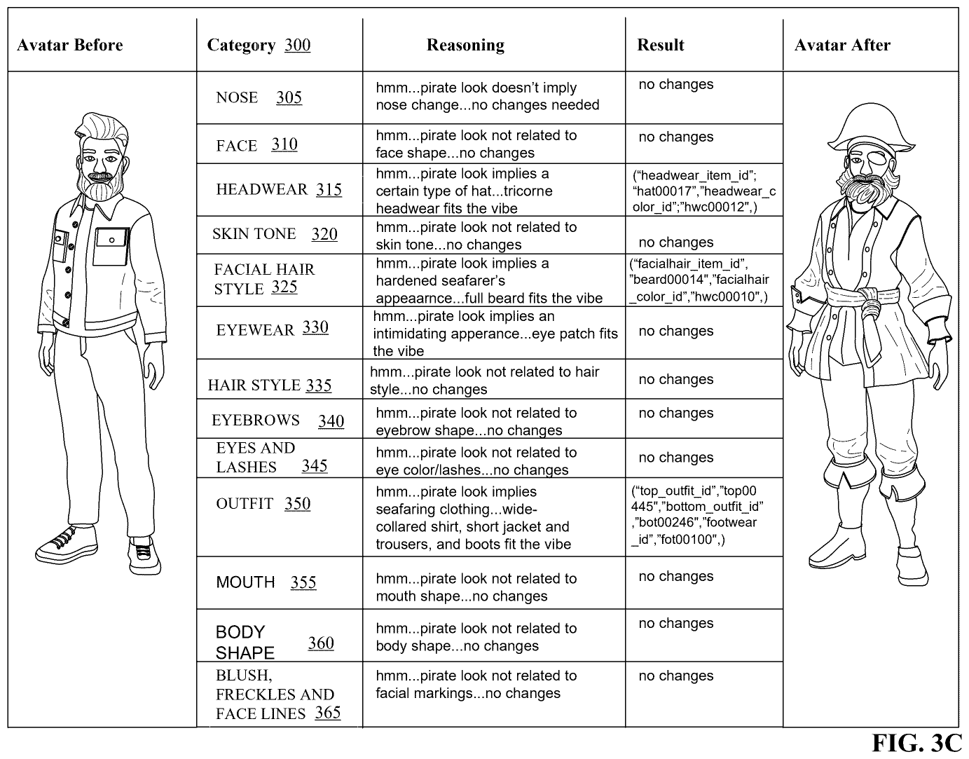

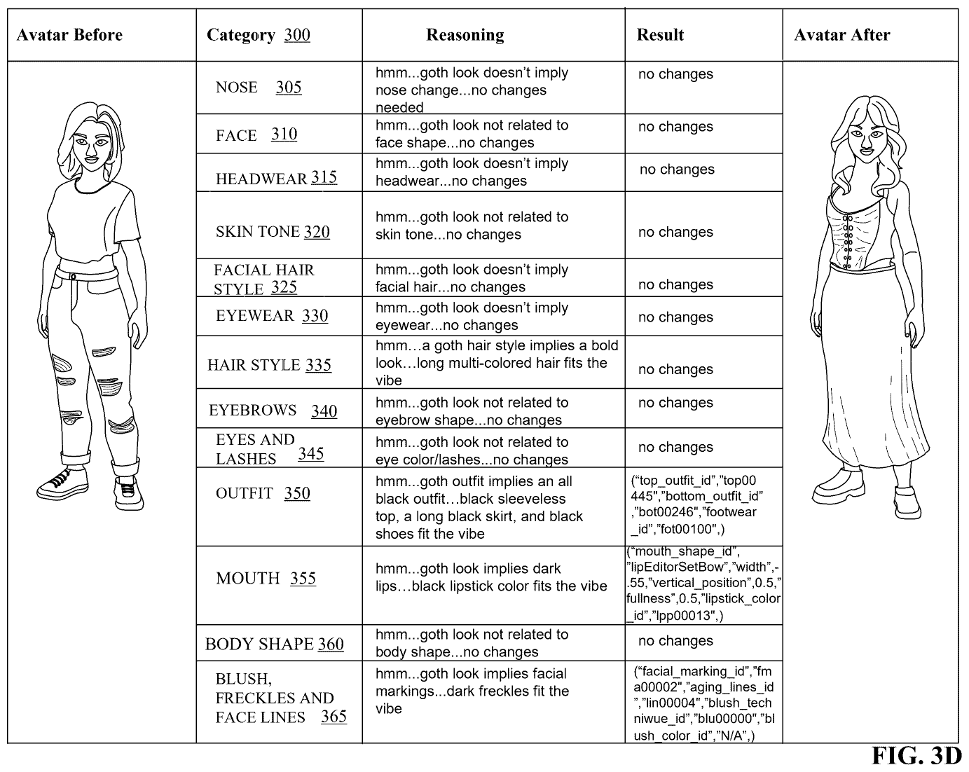

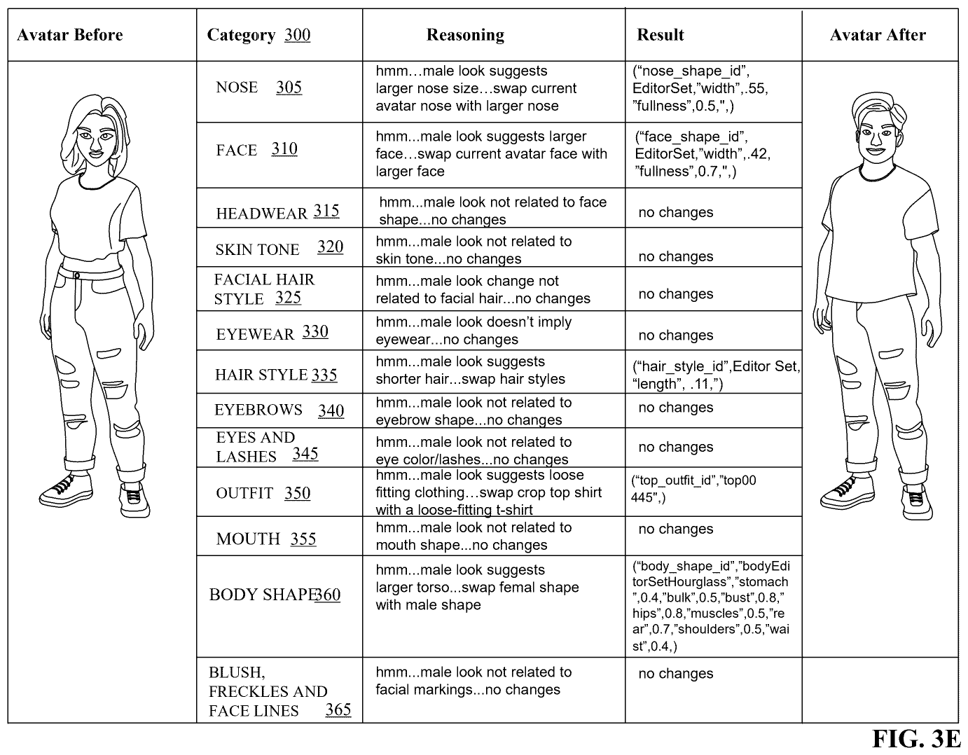

FIGS. 3A, 3B, 3C, 3D and 3E illustrate example avatar modifications based on received user inputs. Additionally, FIGS. 3A and 3C, 3D, 3E also show the parallel processing of multiple avatar attribute categories to enable rapid customization of complex avatar changes. For example, and turning now to FIG. 3A, when a user input is received for modifying an existing avatar (i.e., “Avatar Before) to a target avatar (i.e., “Avatar After”), such as “show me how would I look wearing streetwear,” it may be simultaneously processed by specialized modules for different attribute categories 300 such as headwear 315 and outfit 350, among others, such as nose 305, face 310, skin tone 320, facial hair style 325, eyewear 330, hair style 335, eyebrows 340, eyes and lashes 345, outfit 350, mouth 355, body shape 360, and blush, freckles, and face lines 365. Each of the specialized modules may utilize an LLM to interpret the relevant aspects of the input for its category and determine appropriate attribute changes. There may also be parallel reasoning performed for each component as shown in FIG. 3A. Utilization of a parallel reasoning approach may allow the system 100 to quickly process complex customization requests that affect multiple aspects of the avatar almost simultaneously. For example, the reasoning for clothing (e.g., headwear 315 and outfit 350) that may be relevant to streetwear may include “hmm . . . casual headwear highlights a streetwear look . . . a baseball cap fits the vibe” and “hmm . . . streetwear calls for a light, casual outfit . . . swap sweater for a t-shirt and swap slacks for cargo pants”).

As another example, and turning now to FIG. 3B, when a user input is received, such as “I want a classic white button-down shirt and khaki pants,” it may be simultaneously processed by a specialized module for an attribute category 300 such as outfit 350. The specialized module may utilize an LLM to interpret the relevant aspects of the input for its category and determine appropriate attribute changes. There may also be parallel reasoning performed for the specialized module as shown in FIG. 3B. Utilization of a parallel reasoning approach may allow the system 100 to quickly process complex customization requests that affect multiple aspects of the avatar almost simultaneously. For example, the reasoning for clothing (e.g., outfit 350) that may be relevant to the received user input may include “hmm . . . button-down shirt and khaki pants highlights a semi-casual look . . . swap sneakers with loafers to fit the vibe”).

As yet another example, and turning now to FIG. 3C, when a user input is received, such as “Make me a pirate,” it may be simultaneously processed by specialized modules for multiple attribute categories 300 such as headwear 315, facial hair style 325, eyewear 330, and outfit 350, among others. Each of the specialized modules may utilize an LLM to interpret the relevant aspects of the input for its category and determine appropriate attribute changes. There may also be parallel reasoning performed for the specialized modules as shown in FIG. 3C. Utilization of a parallel reasoning approach may allow the system 100 to quickly process complex customization requests that affect multiple aspects of the avatar almost simultaneously. For example, the reasoning for avatar modifications (e.g., headwear 315, facial hair style 325, eyewear 330, and outfit 350) that may be relevant to a pirate may include “hmm . . . a pirate look implies a certain type of hat . . . tricorne headwear fits the vibe,” “hmm . . . a pirate look implies a seafarer's appearance . . . a full beard fits the vibe,” “hmm . . . a pirate look implies an intimidating appearance . . . an eye patch fits the vibe,” and “hmm . . . a pirate look implies seafaring clothing . . . a wide-collared shirt, short jacket, short trousers, and boots fit the vibe.”

As yet another example, and turning now to FIG. 3D, when a user input is received, such as “Give me a goth-inspired makeover,” it may be simultaneously processed by specialized modules for multiple attribute categories 300 such as hair style 335, outfit 350, mouth 355, and blush, freckles, and face lines 365, among others. Each of the specialized modules may utilize an LLM to interpret the relevant aspects of the input for its category and determine appropriate attribute changes. There may also be parallel reasoning performed for the specialized modules as shown in FIG. 3D. Utilization of a parallel reasoning approach may allow the system 100 to quickly process complex customization requests that affect multiple aspects of the avatar almost simultaneously. For example, the reasoning for avatar modifications (e.g., hair style 335, outfit 350, mouth 355, and blush, freckles, and face lines 365) that may be relevant to a goth-inspired look may include “hmm . . . a goth hair style implies a bold look . . . long multi-colored hair fits the vibe,” “hmm . . . a goth outfit implies an all black outfit . . . a black sleeveless top, a long black skirt, and black shoes fit the vibe,” “hmm . . . a goth look implies dark lips . . . a black lipstick color fits the vibe,” and “hmm . . . a goth look implies facial markings . . . dark freckles fit the vibe.”

As yet another example, and turning now to FIG. 3E, when a user input is received, such as “Turn me into a male version,” it may be simultaneously processed by specialized modules for multiple attribute categories 300 such as nose 305, face 310, hair style 335, outfit 350, and body shape 360, among others. Each of the specialized modules may utilize an LLM to interpret the relevant aspects of the input for its category and determine appropriate attribute changes. There may also be parallel reasoning performed for the specialized modules as shown in FIG. 3D. Utilization of a parallel reasoning approach may allow the system 100 to quickly process complex customization requests that affect multiple aspects of the avatar almost simultaneously. For example, the reasoning for avatar modifications (e.g., nose 305, face 310, hair style 335, outfit 350, mouth 355, and body shape 360) that may be relevant to a gender change may include “hmm . . . a male look suggests a larger nose size . . . swap current avatar nose with a larger nose,” “hmm . . . a male look suggests a larger face . . . swap current avatar face with a larger face,” “hmm . . . a male look suggests shorter hair . . . swap hair styles,” “hmm . . . a male look suggests loose fitting clothing . . . swap crop top shirt with a loose-fitting t-shirt,” and “hmm . . . a male look suggests a larger torso . . . increase torso size.”

With respect to FIGS. 3A, 3B, 3C, 3D, and 3E, discussed above, the LLM may map received the received user input (e.g., text or voice-to-text) into catalog choices and generate predictions or results which may be based on text labels. Text descriptions of avatar assets may be written manually or via a computer vision system. For example, when there is a prompt containing a request or instruction to choose headwear for “how I would look on a beach vacation”, the prompt may cause system 100 to review a list of some or all the headwear descriptions and choose the best one (e.g., choose one randomly within a threshold confidence level) to fit the instruction. An example label associated with a headwear choice may be represented as “hat01: novelty hat, with eyes . . . ,” or the like. The labeling enables flexible matching between user requests and available customization options. An avatar asset such as a clothing item may be analyzed by a computer vision model to identify key visual characteristics. These characteristics may then be used to generate a detailed text description of the item, such as “high-waisted denim shorts, medium wash, snug fit, classic five-pocket design, rolled hem for casual aesthetic.” This text description may then be used by the LLM when processing user requests and determining appropriate customization options.

The system 100 supports a wide range of customization options and use cases. Users can describe desired changes to their avatar using natural language, making the customization process more intuitive and accessible. For instance, a user might input “Make my avatar look more professional” or “Give me a superhero costume.” The system 100 interprets these requests and generates appropriate modifications to the avatar.

Voice command support adds another layer of convenience and accessibility to the system 100. Users can speak their customization requests, which are then converted to text and processed by the system 100. This feature is particularly useful for users who prefer hands-free interaction or those with mobility impairments.

The integration of generative AI capabilities significantly expands the range of customization options available to users. When a user requests a style of clothing or accessory not available in the existing asset catalog, the system 100 can use generative AI to create custom items that match the user's description. This feature allows for creativity and personalization in avatar design.

The system 100 may also utilize a social media trend integration feature (e.g., the media content engine 150) that helps users keep their avatars up to date with current styles and provides inspiration for those who are unsure about how to customize their avatar. By analyzing trending content on social media platforms, the system 100 may suggest popular styles, outfits, or accessories to users. In some examples, the system 100 leverages social media content and trending topics to enhance the customization experience. The system 100 may integrate with media content (e.g., social media platforms) to provide style inspiration for avatar customization. For example, a user could request “show me streetwear inspiration from Instagram” and the system 100 would present relevant fashion images from the platform. The user may then instruct the system 100 to style their avatar based on a selected image, with the AI interpreting the visual elements and applying them to the avatar. Furthermore, the system 100 may utilize trending content and cultural events to generate topical customization suggestions. By analyzing current popular topics or events, the system 100 may offer timely and relevant customization prompts. For instance, during the simultaneous release of two major films, the system 100 may suggest “Dress your avatar to celebrate Barbenheimer,” automatically generating an avatar style that creatively combines elements from both movies. This feature allows the avatar customization to stay current with pop culture trends and provides users with fun, topical ways to express themselves through their avatars.

The system 100 also supports various avatar representation types, including stylized, realistic (codec), and fantastical avatars. This multi-avatar type support allows for a wide range of creative expression, catering to different user preferences and various virtual environment contexts.

This AI-based approach has the ability to learn and improve over time. As the system 100 processes more user requests and receives feedback on its outputs, the system may refine its understanding of user intentions and improve the accuracy of its avatar modifications, which may be presented via user interfaces (e.g., user interface(s) 101) for ease in viewing and enhancing/increasing user interaction by users of the avatars having the avatar modifications being presented via the user interfaces. The system 100 may utilize/implement AI-based approaches to refine understanding of user interactions and improve accuracy of avatar modifications (e.g., augmented reality (AR), virtual reality (VR), and mixed reality (MR) avatar modifications) and may provide technical solutions/technical improvements to technical fields such as virtual character synthesis, graphical element generation, user interface technology, searching a catalog of digital items, avatar creation and editing, and avatar generation.

The system 100 also addresses the challenge of creating consistent avatars across different virtual environments. By storing avatar data in a standardized format, the system 100 allows users to port their avatars between different platforms and/or applications that support the standardized format. This feature of creating consistent avatars across different virtual environments enhances user experience by providing continuity and consistency in self-representation across various virtual spaces.

Security and privacy considerations are also integral to the system 100's design. User data, including avatar designs and customization history, is encrypted and stored securely. Users have control over their data and may choose whether to share their avatar designs or keep them private.

The architecture of system 100 is designed to be scalable and adaptable to future technological advancements. As new AI technologies emerge, these new technologies may be integrated into the system 100 to enhance the system's capabilities further. For example, future versions of the system 100 may incorporate more advanced natural language processing techniques and/or more sophisticated generative AI models to create custom avatar elements.

In terms of implementation, in some example aspects, the system 100 may be deployed as a cloud-based service, allowing for easy updates and maintenance. This may enable the system 100 to leverage cloud computing resources for computationally intensive tasks such as generating custom avatar elements using AI, which may thus conserve processing resources (e.g., processing capacity) of the system 100. In some other example aspects, the system 100 may be a standalone system that is capable of communicating over/via network 102.

The user interface 101 of the system 100 is designed to be intuitive and accessible to users of all technical skill levels. Real-time previews of avatar modifications may be provided and may allow users to view the results of their avatar customization requests immediately. The user interface 101 may also include features such as undo/redo functionality, saving of avatar versions, and the ability to share avatar designs with other users.

For developers and platform owners, the system 100 provides APIs that allow for easy integration with existing virtual environments and/or applications. This enables the AI-based avatar creation and editing capabilities of the system 100 to be incorporated into a wide range of digital products and services.

The disclosed subject matter has numerous potential applications beyond personal avatar creation. It may be used in the entertainment industry for rapidly creating background characters in video games and/or animated films. In e-commerce, the system may be used to create virtual try-on experiences, allowing users to view how clothing items may look on an avatar that resembles the users. In educational settings, it may be used to create engaging, personalized learning experiences in virtual classrooms.

The disclosed artificial intelligence-based avatar creation and editing system assists in the advancement in the technical field of digital self-representation. By leveraging the power of natural language processing, generative AI, and/or social media trend analysis, system 100 may provides users with a level of control and creativity in facilitating creation/generation of their digital avatars. The system's 100 intuitive interface (e.g., user interface 101), coupled with AI capabilities, makes it accessible to users of varying skill levels while still offering/providing deep customization options for those users who desire them. As virtual reality, mixed reality and augmented reality technologies continue to advance and become more prevalent, the exemplary aspects of the present disclosure may provide an increasingly important role in how users represent themselves and interact in digital spaces.

### Exemplary Machine Learning Model

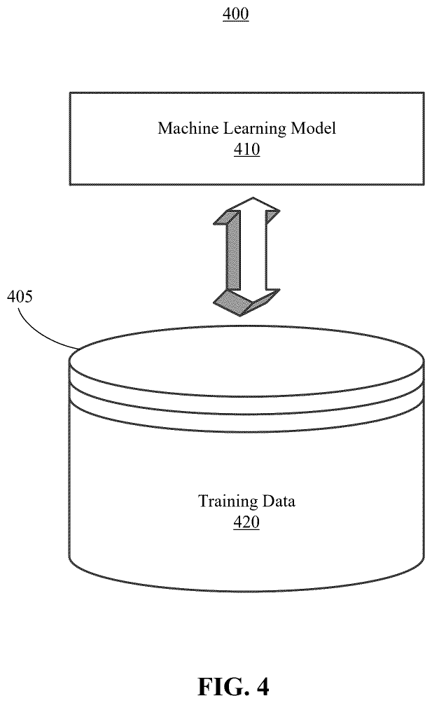

FIG. 4 illustrates a framework 400 that may be associated with machine learning and/or artificial intelligence (AI). The framework 400 may be hosted remotely. Alternatively, the framework 400 may reside within the system 100 shown in FIG. 1 and may be processed/implemented by a device. In some examples, the machine learning model 410 (also referred to herein as artificial intelligence model 410) may be implemented/executed by a network device (e.g., network device 105). In other examples, the machine learning model 410 may be implemented/executed by other devices (e.g., user device 102). The machine learning model 410 may be operably coupled with stored training data 420 in a training database 405. In some examples, the machine learning model 410 may be associated with other operations (e.g., operations 210, 220, 230, 240, 250 of FIG. 2). The machine learning model 410 may be one or more machine learning models.

In another example, the training data 420 may include attributes of thousands of objects. For example, the objects may be a smart phone, person, book, newspaper, sign, car, item and/or the like. Attributes may include but are not limited to the size, shape, orientation, position of the object(s), etc. The training data 420 employed by the machine learning model 410 may be fixed or updated periodically. Alternatively, the training data 420 may be updated in real-time based upon the evaluations performed by the machine learning model 410 in a non-training mode. This is illustrated by the double-sided arrow connecting the machine learning model 410 and stored training data 420.

The machine learning model 410 may be designed to generate one or more avatar associated with one or more received inputs, based in part on utilizing determined contextual information. This information includes fields such as a description, variables defined, data category associated with the variables and the output (e.g., modified or generated avatar), and responses to generated prompts. The machine learning model 410 may be a large language model to generate representations, or embeddings, of one or more of the one or more inputs received. The training data 420 may be utilized to train the machine learning model 410 (e.g., pretrain and/or train in real-time) on a vast amount of textual data (e.g., associated with the one or more inputs), previous responses to one or more prompts generated, previously generated avatars, and/or data capture of a wide range of language patterns and semantic meanings. In return, the trained machine learning model 410 may be utilized to generate additional data (e.g., data samples), which, after additional filtering/processing, are added back to the training data 420. Thus, the machine learning model 410 may form a closed training loop system that self-corrects issues/gaps in the training data 420 through multiple training iterations, thereby improving the quality of the training data 420 as well as improving the quality of the machine learning model 410 itself. For example, the machine-learning model 410 may generate data samples utilizing the following parameters: <avatar before>, <user prompt>, and <avatar after>. The data samples generated by the machine-learning model 410 may then undergo data quality filtering/processing. For example, a data quality analysis may be performed to review the generated data samples and rate the quality of the <avatar after> data in view of the <avatar before> data and the <user prompt> data. Upon the completion of the data quality filtering/processing, identified/determined high quality data samples may be added back into the training data 420. The aforementioned steps/process may then be repeated, as needed, to form the closed training loop system. Additionally, the machine learning model 410 may understand and represent the context of words, terms, phrases and/or the like in a high-dimensional space, effectively capturing/determining the semantic similarities between different received inputs, including descriptions and responses to prompts, even when the inputs may not be exactly the same.

The present disclosure may deploy a machine learning model(s) (e.g., machine learning model 410) that may be flexible, adaptive, automated, temporal, learns quickly and trainable. Manual operations or brute force device operations may be unnecessary for the examples of the present disclosure due to the learning framework aspects of the present disclosure that are implementable by the machine learning model 410.

The present disclosure may be adapted to work across multiple platforms including mobile, web, and virtual reality applications. The present disclosure may further be adapted to accept various input modalities including text, voice, and images. For example, an image input, such as a photo, can be analyzed to generate an avatar that resembles the image. In one example, the present disclosure may utilize computer vision techniques to automatically generate text descriptions of avatar assets such as clothing items. These text descriptions may then be used by the LLM when matching user requests to available options. The customization process utilized by the present disclosure may be iterative, allowing users to continue refining avatars through ongoing natural conversation with a machine learning and/or AI system. This may enable more nuanced and creative avatar designs compared to conventional manual editing techniques.

### Exemplary Computing System

FIG. 5 illustrates an example computer system 500. In examples, one or more computer systems 500 perform one or more steps of one or more methods described or illustrated herein. In particular examples, one or more computer systems 500 (e.g., user device 102 or network device 105) provide functionality described or illustrated herein. In examples, software running on one or more computer systems 500 performs one or more steps of one or more methods described or illustrated herein or provides functionality described or illustrated herein. Examples include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example, and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In examples, computer system 500 includes a processor 502, memory 504, storage 506, an input/output (I/O) interface 508, a communication interface 510, and a bus 512). Although this disclosure describes and illustrates a particular computer system having a particular number of particular components in a particular arrangement, this disclosure contemplates any suitable computer system having any suitable number of any suitable components in any suitable arrangement.

In examples, processor 502 includes hardware for executing instructions, such as those making up a computer program. As an example, and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular examples, processor 502 may include one or more internal caches for data, instructions, or addresses. This disclosure contemplates processor 502 including any suitable number of any suitable internal caches, where appropriate. As an example, and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular examples, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In examples, memory 504 includes main memory for storing instructions for processor 502 to execute or data for processor 502 to operate on. As an example, and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular examples, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In examples, one or more memory management units (MMUs) reside between processor 502 and memory 504 and facilitate accesses to memory 504 requested by processor 502. In particular examples, memory 504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In examples, storage 506 includes mass storage for data or instructions. As an example, and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In examples, storage 506 is non-volatile, solid-state memory. In particular examples, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In examples, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In examples, communication interface 510 includes hardware, software, or both providing one or more interfaces for communication (such as, for example, packet-based communication) between computer system 500 and one or more other computer systems 500 or one or more networks. As an example, and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example, and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular examples, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, computer readable medium or any suitable combination of two or more of these, where appropriate. A computer-readable non-transitory storage medium may be volatile, non-volatile, or a combination of volatile and non-volatile, where appropriate.

### Alternative Examples

The foregoing description of the examples has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the examples in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one example, a software component is implemented with a computer program product comprising a computer-readable medium containing computer program code, which can be executed by a computer processor for performing any or all of the steps, operations, or processes described.

Examples also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer-readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples also may relate to a product that is produced by a computing process described herein. Such a product may comprise information resulting from a computing process, where the information is stored on a non-transitory, tangible computer-readable storage medium and may include any example of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

What is claimed:

1. A method comprising:
receiving a user input associated with a set of avatar modifications;
processing the user input, by a large language model fine-tuned, to facilitate avatar editing;
generating, based on the processed user input, the set of avatar modifications within constraints of an available asset catalog;
applying the generated set of avatar modifications to update a target avatar; and
outputting the updated target avatar to a display.

2. The method of claim 1, wherein the user input comprises a natural language prompt describing the set of avatar modifications.

3. The method of claim 1, wherein the processing the user input comprises:
analyzing the user input to determine, from the set of avatar modifications, intended modifications to an appearance, a style, or a role associated with the target avatar; and
mapping the intended modifications to available assets in the asset catalog.

4. The method of claim 1, further comprising:
determining a limitation associated with performing a requested modification based on the available assets in the asset catalog;
selecting one or more alternate assets that approximate the requested modification; and
applying the alternate assets to update the target avatar.

5. The method of claim 1, wherein the user input comprises text converted from one or more voice commands.

6. The method of claim 1, wherein the large language model is fine-tuned utilizing one or more pre-existing avatar elements and corresponding natural language descriptions.

7. The method of claim 1, further comprising:
presenting a set of pre-approved prompts associated with the set of avatar modifications; and
receiving a selection of one of the pre-approved prompts as the user input.

8. The method of claim 1, further comprising:
integrating with a generative artificial intelligence system to create custom clothing or accessories associated with the avatar based on the user input.

9. The method of claim 1, further comprising:
generating suggestions comprising inspirations associated with proposed avatar modifications based on trending social media content.

10. The method of claim 1, wherein the generated set of avatar modifications comprises face tuning, style recommendations, or role-playing appearances.

11. An apparatus comprising:
one or more processors; and
a memory storing instructions that, when executed by the one or more processors, cause the apparatus to:
receive a user input associated with a set of avatar modifications;
process the user input, by a large language model fine-tuned, to facilitate avatar editing;
generate, based on the processed user input, the set of avatar modifications within constraints of an available asset catalog;
apply the generated set of avatar modifications to update a target avatar; and
output the updated target avatar to a display.

12. The apparatus of claim 11, wherein the user input comprises a natural language prompt describing the set of avatar modifications.

13. The apparatus of claim 11, wherein when the one or more processors execute the instructions to process the user input, the apparatus is further configured to:
analyze the user input to determine, from the set of avatar modifications, intended modifications to an appearance, a style, or a role associated with the target avatar; and
map the intended modifications to available assets in the asset catalog.

14. The apparatus of claim 11, wherein the one or more processors further execute the instructions to:
determine limitations associated with performing a requested modification based on the available assets in the asset catalog;
select one or more alternate assets that approximate the requested modification; and
apply the alternate assets to update the target avatar.

15. The apparatus of claim 11, wherein the large language model is fine-tuned utilizing one or more pre-existing avatar elements and corresponding natural language descriptions.

16. The apparatus of claim 11, wherein the one or more processors further execute the instructions to:
integrate with a generative artificial intelligence system to create custom clothing or accessories associated with the avatar based on the user input.

17. The apparatus of claim 11, wherein the one or more processors further execute the instructions to:
present a set of pre-approved prompts associated with the set of avatar modifications; and
receive a selection of one of the pre-approved prompts as the user input.

18. The apparatus of claim 11, wherein the one or more processors further execute the instructions to:
generate suggestions comprising inspirations associated with proposed avatar modifications based on trending social media content.

19. A non-transitory computer-readable medium storing instructions that, when executed, cause:
receiving a user input associated with a set of avatar modifications;
processing the user input, by a large language model fine-tuned, to facilitate avatar editing;
generating, based on the processed user input, the set of avatar modifications within constraints of an available asset catalog;
applying the generated set of avatar modifications to update a target avatar; and
outputting the updated target avatar to a display.

20. The computer-readable medium of claim 19, wherein the instructions, when executed, cause:
analyzing the user input to determine, from the set of avatar modifications, intended modifications to an appearance, a style, or a role associated with the target avatar; and
mapping the intended modifications to available assets in the asset catalog.
